(19) United States
(12) Patent Application Publication
(10) Pub. No.: US 2026/0046963 A1
(43) Pub. Date: Feb. 12, 2026

(54) SYSTEM AND COMMUNICATION DEVICE

(71) Applicant: OMRON HEALTHCARE Co., Ltd., Kyoto (JP)

(72) Inventors: Tetsuzo OKAZAKI, Kyoto (JP); Yasunori FUKUDA, Kyoto (JP)

(21) Appl. No.: 19/363,149

(22) Filed: Oct. 20, 2025

Related U.S. Application Data
(63) Continuation of application No. PCT/JP2024/000652, filed on Jan. 12, 2024.

(30) Foreign Application Priority Data
Jun. 7, 2023 (JP) 2023-093951

(51) Int. Cl. H04W 76/15; H04W 12/03; H04W 12/06

(52) U.S. Cl. CPC H04W 76/15; H04W 12/03; H04W 12/06

(57) ABSTRACT

A system and a communication device capable of easily performing pairing of an intended communication device and a measurement device. An information analysis system includes: a blood pressure monitor including a first communication unit configured to communicate via communication method capable of pairing; and a communication device including a second communication unit configured to communicate via a pairing, wherein the communication device includes a radio wave shielding portion erected in a direction intersecting a placement surface and disposed surrounding a communication antenna of the second communication unit, wherein the communication device is placed on the placement surface, and a distance from the placement surface to an end edge on a side opposite to the placement surface side of the radio wave shielding portion orthogonal to the placement surface is equal to or greater than a height of the blood pressure monitor placed on the placement surface in the direction.

### CROSS-REFERENCE TO RELATED APPLICATIONS

This application is the U.S. national stage application filed pursuant to 35 U.S.C. 365(c) and 120 as a continuation of International Patent Application No. PCT/JP2024/000652, filed January 12, 2024, which application claims priority to Japanese Patent Application No. 2023-093951, filed June 7, 2023, which applications are incorporated herein by reference in their entireties.

### TECHNICAL FIELD

The present invention relates to a system and a communication device.

### BACKGROUND ART

The measurement device described in the present specification includes a biological information measurement device that measures biological information such as a weight, a body composition, a blood pressure, a pulse, a heart rate, a body temperature, blood glucose, or a blood oxygen saturation level, and an activity amount measurement device that measures an activity amount such as the number of steps, a walking distance, or calorie consumption. The measurement device includes a measurement sensor for measuring a measurement target amount. The measurement target amount of the measurement sensor includes biological information such as a weight, a body fat percentage, a blood pressure value, a pulse rate, a heart rate, a body temperature, a blood glucose level, or a blood oxygen saturation level, and an activity amount such as the number of steps, a walking distance, or calorie consumption, depending on the measurement device. A measurement result of such a measurement device is recorded and analyzed by an information terminal such as a smartphone, a tablet terminal, a notebook personal computer, and a desktop personal computer.

In the case of recording and analyzing such a measurement result, it is desirable that the information terminal can automatically acquire the measurement result from the measurement device, instead of the user inputting the measurement result to the information terminal each time. Specifically, for example, a method in which the information terminal transfers the measurement result from the measurement device using near-field wireless communication such as Bluetooth (trade name) is conceivable.

Patent Document 1 describes a system in which a client device worn by a user and a master device are configured to be capable of wireless communication, and biological information of the user transmitted from the client device to the master device is sent to a personal data management device via satellites.

Patent Document 2 describes a system in which a measurement module and a central processing unit in a patient monitoring system are wirelessly connected and transmit data to one another.

### CITATION LIST

### Patent Literature

Patent Document 1: JP 2002-191566 A

Patent Document 2: JP 2018-526121 A

### SUMMARY OF INVENTION

### Technical Problem

In order to perform secure near-field wireless communication between a measurement device and an information terminal or similar device, processing of pairing the measurement device and the device is necessary. The pairing refers to processing of sharing encryption information used for near-field wireless communication between the measurement device and the device. For example, in a case where a clinical research is performed by collecting biological information and activity amounts of a large number of users, it is necessary to collect the measurement devices lent to the respective users, pair the measurement devices with the device one by one, and transmit information from the measurement devices to the device. However, in a case where the device and the plurality of measurement devices are arranged in the same space, there is a possibility that pairing is performed with a pair including an unintended device and measurement device, and work efficiency is reduced. In addition, in a case where a plurality of devices are prepared in order to improve the work efficiency, the plurality of devices and the plurality of measurement devices are disposed in the same space. In this case, for example, when the operation of pairing the first device and the first measurement device and the operation of pairing the second device and the second measurement device are performed in parallel, there is a possibility that pairing is performed between the first device and the second measurement device or pairing is performed between the second device and the first measurement device, and there is a possibility that the efficiency of the operation is reduced even though a plurality of devices are prepared.

An object of the technology of the present disclosure is to provide a system capable of easily performing communication between an intended pair of a device and a measurement device even in a space where a device and a plurality of measurement devices are present and a communication device that can be used in the system.

### SOLUTION TO PROBLEM

The technology of the present disclosure is as follows. Note that components and the like according to the following embodiments are indicated in parentheses, but the components are not limited thereto.

(1)A system (information analysis system 100) including: a measurement device (blood pressure monitor 10, activity meter 10Z) including a first near-field wireless communication unit (first communication unit 12) configured to communicate via a communication method capable of pairing; and a communication device (communication device 20) including a second near-field wireless communication unit (second communication device 22) configured to communicate via a communication method capable of pairing, wherein the communication device includes a radio wave shielding portion (radio wave shielding portion 25A) erected in a direction intersecting a placement surface (placement surface 41) and disposed surrounding an antenna (communication antenna 22A) of the second near-field wireless communication unit, in a state where the communication device is placed on the placement surface, and a distance (distance L1) from the placement surface to an end edge, on a side opposite to a side of the placement surface, of the radio wave shielding portion in a direction orthogonal to the placement surface is equal to or greater than a height (height L2) of the measurement device placed on the placement surface in the direction.

According to (1), the radio wave characteristics of the communication device can be made to have directivity upward of the placement surface by the radio wave shielding portion. Since the distance from the end edge of the radio wave shielding portion to the placement surface is equal to or greater than the height of the measurement device placed on the placement surface, in a situation where the communication device and the measurement device are disposed adjacent to each other on the placement surface, the intensity of the radio waves of the measurement device received by the communication device can be reduced. On the other hand, in a situation where the measurement device is located above the communication device, the intensity of the radio waves of the measurement device received by the communication device can be increased. Thus, even in a situation where a plurality of communication devices and a plurality of measurement devices are placed on the same placement surface and the communication devices perform operations of pairing with any of the plurality of measurement devices in parallel, for example, only the measurement device disposed above each communication device can be specified as a pairing partner of the communication device by using the radio wave intensity received by the communication device. For example, all of the measurement devices and the communication devices can be efficiently paired by simply repeating the operation of placing a measurement device on each communication device, performing pairing with the measurement device, and, when the pairing is completed, placing another measurement device on each communication device and performing pairing with the measurement device. Accordingly, information measured by the plurality of measurement devices can be safely and efficiently collected by the communication device and used for clinical research or the like.

(2) In the system according to (1), the antenna includes a leaky coaxial cable.

According to (2), since the emission range of radio waves from the antenna can be further restricted, it is possible to prevent pairing from being performed between the communication device and the measurement device that is not located above the communication device.

(3) In the system according to (1) or (2), the communication device includes a processor (processor 21), and the processor, in a case where a broadcast signal is received by the second near-field wireless communication unit, performs pairing processing with, from among the measurement devices which are transmission sources of the broadcast signals, the measurement device with a radio wave intensity of near-field wireless communication that is equal to or greater than a threshold.

According to (3), it is possible to prevent pairing from being performed between the communication device and the measurement device that is not located above the communication device.

(4) In the system according to (3), the processor obtains identification information of the measurement device corresponding to a target of the pairing and shares encryption information with the measurement device in a case where authentication information corresponding to the identification information can be obtained from a storage unit.

According to (4), by storing the identification information and the authentication information of the measurement device in the storage unit in advance in association with each other, it is possible to complete pairing between the measurement device and the communication device without performing a complicated operation (for example, input of a number, a button operation, or the like) in the communication device in a state where the measurement device is disposed above the communication device. Accordingly, the task of pairing multiple measurement devices and a communication device can be performed efficiently.

(5) A communication device (communication device 20) provided with a near-field wireless communication unit (second communication unit 22) configured to communicate via a communication method capable of pairing, the communication device including: a processor (processor 21), wherein an antenna (communication antenna 22A) of the near-field wireless communication unit has directivity in a direction orthogonal to a placement surface (placement surface 41), in a state where the communication device is placed on the placement surface, the processor, in a case where a broadcast signal is received by the near-field wireless communication unit, performs pairing processing with, from among devices that are transmission sources of the broadcast signal, a device with a radio wave intensity of near-field wireless communication that is equal to or greater than a threshold, and in the processing, the processor obtains identification information of the device corresponding to a target of the pairing and shares encryption information with the device in a case where authentication information corresponding to the identification information can be obtained from a storage unit.

According to (5), by storing the identification information and the authentication information of the measurement device in the storage unit in advance in association with each other, it is possible to complete pairing between the measurement device and the communication device without performing a complicated operation in the communication device by only placing the measurement device above the communication device. Accordingly, the task of pairing multiple measurement devices and a communication device can be performed efficiently. Further, the configuration of the communication device can be simplified to reduce the cost.

(6) A communication device including: a near-field wireless communication unit (second communication unit 22) configured to communicate via a communication method capable of pairing; and a radio wave shielding portion (radio wave shielding portion 25A) erected in a direction intersecting a placement surface (placement surface 41) and disposed surrounding an antenna (communication antenna 22A) of the near-field wireless communication unit, in a state where the communication device is placed on the placement surface, wherein a distance (distance L1) from the placement surface to an end edge, on a side opposite to a side of the placement surface, of the radio wave shielding portion in a direction orthogonal to the placement surface is in a range from 15 mm to 300 mm.

According to (6), the radio wave characteristics of the communication device can be made to have directivity upward of the placement surface by the radio wave shielding portion. The distance from the end edge of the radio wave shielding portion to the placement surface is in a range from 15 mm to 300 mm, which is equal to or greater than the height of the measurement device (activity meter, blood pressure monitor, or the like) when the measurement device is placed on the placement surface. Thus, in a situation where the communication device and the measurement device are disposed adjacent to each other on the placement surface, the intensity of the radio waves of the measurement device received by the communication device can be reduced. On the other hand, in a situation where the measurement device is located above the communication device, the intensity of the radio waves of the measurement device received by the communication device can be increased. Thus, even in a situation where a plurality of communication devices and a plurality of measurement devices are placed on the same placement surface and the communication devices perform operations of pairing with any of the plurality of measurement devices in parallel, for example, only the measurement device disposed above each communication device can be specified as a pairing partner of the communication device by using the radio wave intensity received by the communication device. Accordingly, information measured by the plurality of measurement devices can be safely and efficiently collected by the communication device and used for clinical research or the like.

### ADVANTAGEOUS EFFECTS OF INVENTION

According to the technology of the present disclosure, even in a space where a device and a plurality of measurement devices are present, pairing of an intended device and measurement device can be easily performed.

### BRIEF DESCRIPTION OF DRAWINGS

Various embodiments are disclosed, by way of example only, with reference to the accompanying schematic drawings in which corresponding reference symbols indicate corresponding parts, in which:

FIG. 1 is a schematic diagram illustrating a schematic configuration of an information analysis system 100.

FIG. 2 is a block diagram illustrating an example of a configuration of a blood pressure monitor 10 illustrated in FIG. 1.

FIG. 3 is a block diagram illustrating an example of a configuration of a communication device 20 illustrated in FIG. 1.

FIG. 4 is a perspective view schematically illustrating an example of the external appearance of the blood pressure monitor 10 illustrated in FIG. 1 and an example of the external appearance of an activity meter which is one of the measurement devices.

FIG. 5 is an exploded perspective view schematically illustrating an example of the external appearance of the communication device 20 illustrated in FIG. 1.

FIG. 6 is a side view illustrating a state in which an upper-arm blood pressure monitor 10X, a wrist blood pressure monitor 10Y, an activity meter 10Z, and the communication device 20 are placed on a placement surface 41.

FIG. 7 is a sequence chart illustrating a procedure of processing when pairing a blood pressure monitor A and the communication device 20 in a case where the blood pressure monitor A and a blood pressure monitor B exist as the blood pressure monitors 10.

FIG. 8 is a cross-sectional schematic view of the communication device 20 illustrating a modification of a communication antenna 22A mounted on the communication device 20.

### DESCRIPTION OF EMBODIMENTS

Summary of System of Technology of Present Disclosure

A system according to the technology of the present disclosure includes a measurement device including a first near-field wireless communication unit that performs communication by a communication method capable of pairing, and a communication device including a second near-field wireless communication unit that performs communication by a communication method capable of pairing. The communication device includes a radio wave shielding portion that, when placed on a placement surface, is erected in a direction intersecting the placement surface and is disposed to surround an antenna of the second near-field wireless communication unit, and a distance between an end edge of the radio wave shielding portion on a side opposite to the placement surface side in a direction orthogonal to the placement surface and the placement surface is equal to or greater than a height of the measurement device placed on the placement surface in the direction. With this configuration, the radio wave characteristics of the communication device can be made to have directivity upward of the placement surface by the radio wave shielding portion. Since the distance from the end edge of the radio wave shielding portion to the placement surface is equal to or greater than the height of the measurement device placed on the placement surface, in a situation where the communication device and the measurement device are disposed adjacent to each other on the placement surface, the intensity of the radio waves of the measurement device received by the communication device can be reduced. On the other hand, in a situation where the measurement device is located above the communication device, the intensity of the radio waves of the measurement device received by the communication device can be increased. Thus, even in a situation where a plurality of communication devices and a plurality of measurement devices are placed on the same placement surface and the communication devices perform operations of pairing with any of the plurality of measurement devices in parallel, for example, only the measurement device disposed above each communication device can be specified as a pairing partner of the communication device by using the radio wave intensity received by the communication device. For example, all of the measurement devices and the communication devices can be efficiently paired by simply repeating the operation of placing a measurement device on each communication device, performing pairing with the measurement device, and, when the pairing is completed, placing another measurement device on each communication device and performing pairing with the measurement device. Accordingly, information measured by the plurality of measurement devices can be safely and efficiently collected by the communication device and used for clinical research or the like.

An information analysis system 100 which is an embodiment of the system will be described below.

### System Configuration

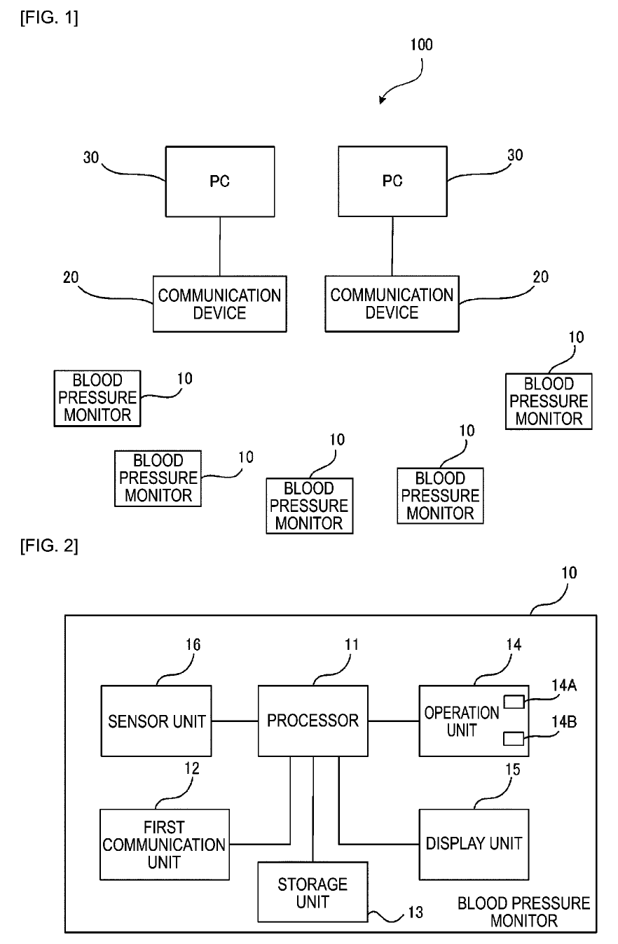

FIG. 1 is a schematic diagram illustrating a schematic configuration of the information analysis system 100. The information analysis system 100 includes a blood pressure monitor 10, which is an example of a measurement device, a communication device 20, and a personal computer (PC) 30, which is an example of the information terminal, and is a system for analyzing the measurement data of the blood pressure monitor 10 at the PC 30. In the example of FIG. 1, the information analysis system 100 is constituted by a plurality of (five as an example) the blood pressure monitors 10, a plurality of (two as an example) the communication devices 20, and PCs 30 numbering the same as the total number of communication devices 20. The blood pressure monitor 10 is configured to measure blood pressure information in a non-invasive manner.

The blood pressure monitor 10 and the communication device 20 are configured to be able to communicate with each other by near-field wireless communication. The near-field wireless communication method is a method that enables secure communication by pairing (sharing of encryption information for encryption of communication), and for example, Bluetooth (registered trademark) (hereinafter referred to as BLE) can be adopted. The PC 30 and the communication device 20 have a wired connection via a cable such as a universal serial bus (USB) cable and are configured to be able to communicate with each other. The PC 30 and the communication device 20 may be wirelessly connected to each other.

The information analysis system 100 is used, for example, in clinical research. A researcher who conducts clinical research lends the blood pressure monitor 10 to each of a plurality of participants and gets each participant to periodically measure blood pressure information. After a certain period of time, the researcher collects the blood pressure monitor 10 from each of the participants and performs an operation of taking the measurement data stored in the collected blood pressure monitors 10 into the PC 30 via the communication device 20. The PC 30 is connected to a network such as the Internet or an intranet, and the measurement data taken into the PC 30 is uploaded to a server (not illustrated) and managed. In the information analysis system 100, the PC 30 is not essential. For example, if the communication device 20 has a function of uploading measurement data to a server, the communication device 20 may be configured to directly connect to a network. In addition, although in this configuration, one communication device 20 is connected to one PC 30, a configuration in which a plurality of the communication devices 20 connect to one PC 30 may be used. In addition, although the plurality of communication devices 20 are provided, instead one communication device 20 may be provided.

In order to move the measurement value of the blood pressure monitor 10 into the PC 30, it is necessary to pair the blood pressure monitor 10 with any one of the communication devices 20. The operation at the time of pairing will be described later.

### Blood pressure Monitor

FIG. 2 is a block diagram illustrating an example of a configuration of the blood pressure monitor 10 illustrated in FIG. 1. The blood pressure monitor 10 includes a processor 11, a first communication unit 12, a storage unit 13, an operation unit 14, a display unit 15, and a sensor unit 16.

The sensor unit 16 includes a pressure sensor disposed in a cuff portion of the blood pressure monitor 10 as a measurement sensor, and detects, by the pressure sensor, a pulse wave from a blood vessel of the user under an appropriate cuff pressure. The blood pressure monitor 10 can calculate the blood pressure information including the maximum blood pressure, the minimum blood pressure, and the pulse based on the pulse wave detected by the sensor unit 16.

The first communication unit 12 is a communication interface (in this example, a BLE chip) for performing the near-field wireless communication, and includes a communication antenna and various circuits.

The storage unit 13 includes a non-transitory storage medium such as a flash memory in addition to a working memory such as a random access memory (RAM). Various types of information such as measured blood pressure information are stored in this storage medium.

The operation unit 14 is an input unit such as a button or a touch panel that receives an input from the user, and receives various operations such as ON/OFF of a power supply, start of measurement of blood pressure information, and selection of an item from the user. The operation unit 14 includes a measurement start button 14A for instructing to start measuring the blood pressure information, and a communication button 14B for operating the first communication unit 12 (enabling the near-field wireless communication). The measurement start button 14A and the communication button 14B may be hardware buttons, or may be software buttons displayed on the display unit 15 equipped with a touch panel.

The display unit 15 includes, for example, a display such as an organic electro-luminescence (EL) display, a liquid crystal display, or the like, and displays the measured blood pressure information and the like.

The processor 11 comprehensively controls each unit of the blood pressure monitor 10. In detecting pressing of the measurement start button 14A included in the operation unit 14, the processor 11 receives an instruction to start measuring, pressurizes the cuff, and calculates the blood pressure information based on the pulse waves detected by the sensor unit 16 under an appropriate pressure of the cuff. Then, the processor 11 displays the calculated blood pressure information on the display unit 15. The processor 11 controls each component of the blood pressure monitor 10 so as to execute processing according to a user's operation performed via the operation unit 14.

When a short-time press of the communication button 14B included in the operation unit 14 is detected, the processor 11 activates the first communication unit 12. When the communication connection with the paired device is established, the processor 11 performs control to transmit the measurement data stored in the storage unit 13 from the first communication unit 12 to the device. When the processor 11 detects a continual press operation of the communication button 14B for a predetermined amount of time (a so-called long-press operation), the processor 11 causes the operation mode of the blood pressure monitor 10 to transition to the pairing mode. The pairing mode is a mode in which a device with which pairing is to be performed is detected and pairing is performed with the device.

In FIG. 1, the blood pressure monitor 10 is illustrated as an example of the measurement device, but the blood pressure monitor 10 can be replaced with a weight scale, a body composition meter, a pulse rate meter, a heart rate meter, a thermometer, a blood glucose meter, a pulse oximeter, an activity meter, or the like. In any of these measurement devices, the sensor unit 16 includes various measurement sensors (a pressure sensor, a pulse wave sensor, a blood glucose sensor, a photoelectric sensor, a temperature sensor, an acceleration sensor, or the like) for measuring a physical quantity of a measurement target. In a case where the measurement device is a biological information measurement device, when the processor 11 detects pressing of a measurement start button 14A included in the operation unit 14, the processor 11 operates a measurement sensor (a pressure sensor, a pulse wave sensor, a blood glucose sensor, a photoelectric sensor, a temperature sensor, or the like) included in the sensor unit 16 to measure biological information. In a case where the measurement device is an activity amount measurement device, when the activity amount measurement device is moved, information corresponding to the movement is output from a measurement sensor (an acceleration sensor, an angular velocity sensor, or the like) included in the sensor unit 16.

### Communication Device

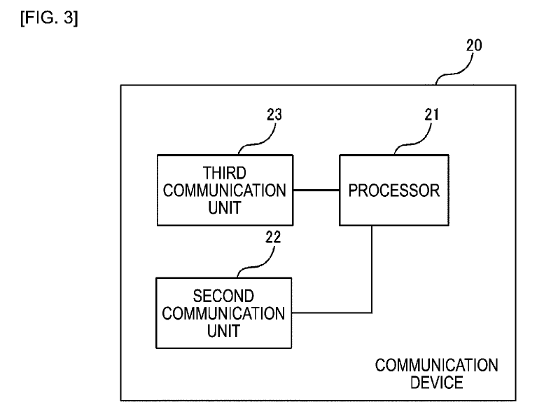

FIG. 3 is a block diagram illustrating an example of a configuration of the communication device 20 illustrated in FIG. 1. The communication device 20 includes a processor 21, a second communication unit 22, and a third communication unit 23.

The second communication unit 22 is a communication interface for performing near-field wireless communication with the blood pressure monitor 10 and includes a communication antenna (communication antenna 22A described later) and various circuits.

The third communication unit 23 is a communication interface for performing wired communication with the PC 30.

The processor 21 comprehensively controls each unit of the communication device 20. The processor 21 is, for example, a central processing unit (CPU) that is a general-purpose processor executing software (program) to perform various functions, a programmable logic device (PLD) that is a processor whose circuit configuration can be changed after manufacturing, such as a field programmable gate array (FPGA), or a dedicated electric circuit that is a processor having a circuit configuration dedicatedly designed to execute specific processing, such as an application specific integrated circuit (ASIC). The processor 21 may be configured with one processor, or may be configured with a combination of two or more processors of the same type or different types (for example, a plurality of FPGAs or a combination of a CPU and an FPGA). More specifically, the hardware structure of the processor 21 is an electric circuit (circuitry) in which circuit elements such as semiconductor elements are combined.

### External Configuration of Blood Pressure Monitor

The blood pressure monitor 10 used in the information analysis system 100 illustrated in FIG. 1 is a blood pressure monitor of a type in which a user wraps and fixes a cuff around a target measurement site, and a so-called arm-in type blood pressure monitor is excluded.

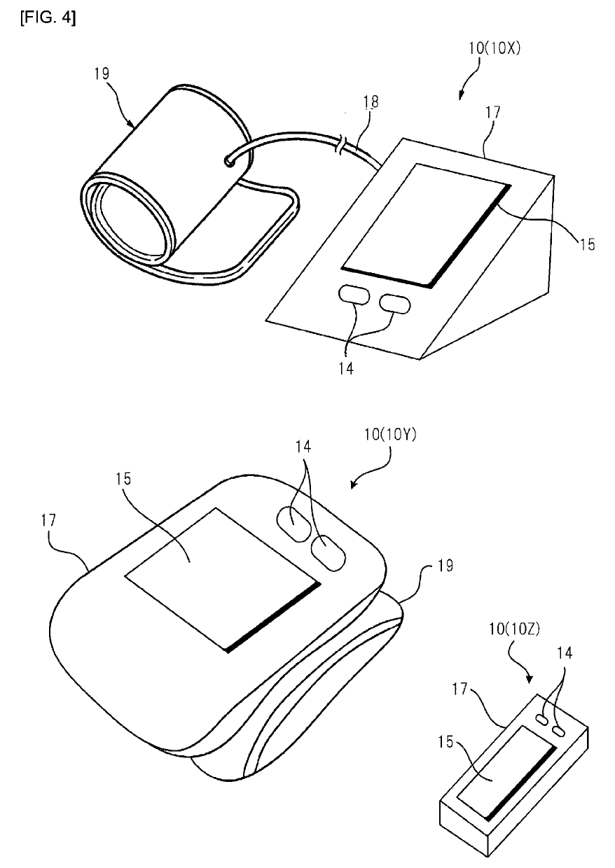

FIG. 4 is a perspective view schematically illustrating an example of the external appearance of the blood pressure monitor 10 illustrated in FIG. 1 and an example of the external appearance of an activity meter which is one of the measurement devices. FIG. 4 illustrates an upper-arm blood pressure monitor 10X and a wrist blood pressure monitor 10Y as the blood pressure monitor 10. The upper-arm blood pressure monitor 10X includes a main body 17 including the display unit 15, the operation unit 14, and the processor 11 (not illustrated); a cuff 19 wound around and fixed to the upper arm, and an air tube 18 connecting the main body 17 and the cuff 19. Hereinafter, a state in which the main body 17 is placed on a flat placement surface so that information displayed on the display unit 15 can be checked from above the placement surface is defined as a standard placement state of the upper-arm blood pressure monitor 10X.

The wrist blood pressure monitor 10Y includes the main body 17 including the display unit 15, the operation unit 14, the processor 11 (not illustrated), and the like and the cuff 19 wound around the wrist and fixed. Hereinafter, a state in which the main body 17 and the cuff 19 are placed on a flat placement surface so that information displayed on the display unit 15 can be checked from above the placement surface is defined as a standard placement state of the wrist blood pressure monitor 10Y.

FIG. 4 illustrates an activity meter 10Z. The activity meter 10Z includes only the portion of the blood pressure monitor 10 corresponding to the main body 17 and has a rectangular parallelepiped external shape. Hereinafter, a state in which the activity meter 10Z is placed on a flat placement surface so that information displayed on the display unit 15 can be checked from above the placement surface is described as a standard placement state of the activity meter 10Z.

### External Configuration of Communication Device

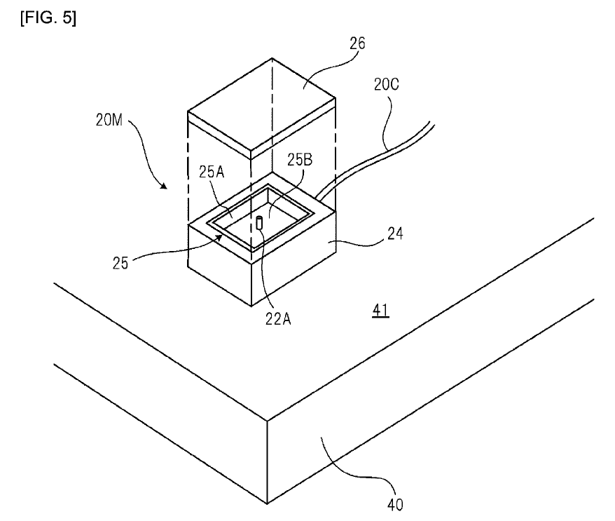

FIG. 5 is an exploded perspective view schematically illustrating an example of the external appearance of the communication device 20 illustrated in FIG. 1. The communication device 20 includes a main body 20M having a rectangular parallelepiped shape and a cable 20M connected to the main body 20C and is used by placing the main body 20M on a placement surface 41 (flat surface) which is the surface of a desk 40. The main body 20M has a rectangular parallelepiped shape, but is not limited thereto, and may have other shapes. For example, the main body 20M may have a cylindrical shape.

The main body 20M includes a main body 24 including a recess 25 on a surface (hereinafter referred to as an upper surface) opposite to a surface (hereinafter referred to as a bottom surface) facing the placement surface 41 in a state of being placed on the placement surface 41 and a flat plate-shaped lid portion 26 covering the recess 25 of the main body 24. The lid portion 26 is fixed to the upper surface of the main body 24.

The main body 24 includes the processor 21, the second communication unit 22, and the third communication unit 23 illustrated in FIG. 3. The communication antenna 22A included in the second communication unit 22 is provided in the recess 25. The communication antenna 22A is constituted by a dipole antenna, a mono-pole antenna, an inverted-F antenna, a loop antenna, a Yagi antenna, or the like. It is preferable that the communication antenna 22A is configured such that, in a state where the main body 24 is placed on the placement surface 41 as illustrated in FIG. 5, the radio wave intensity in a direction perpendicular to the placement surface 41 and away from the placement surface 41 is greater than the radio wave intensity in directions other than this direction (that is, the communication antenna 22A has directivity upward of the placement surface 41).

The recess 25 is provided with a radio wave shielding portion 25A that is erected in a direction intersecting (in the example of FIG. 5, orthogonal to) the placement surface 41 and is disposed surrounding the communication antenna 22A. A rectangular plate-shaped radio wave shielding portion 25B is provided on the bottom surface of the recess 25, and the communication antenna 22A is disposed on the radio wave shielding portion 25B. The radio wave shielding portion 25A has a rectangular frame shape that is configured to rise vertically from the peripheral edge of the radio wave shielding portion 25B. The radio wave shielding portion 25A and the radio wave shielding portion 25B are each formed of a shielding member capable of shielding radio waves emitted from the communication antenna 22A. The shielding member is made of a material that absorbs or reflects, or absorbs and reflects radio waves.

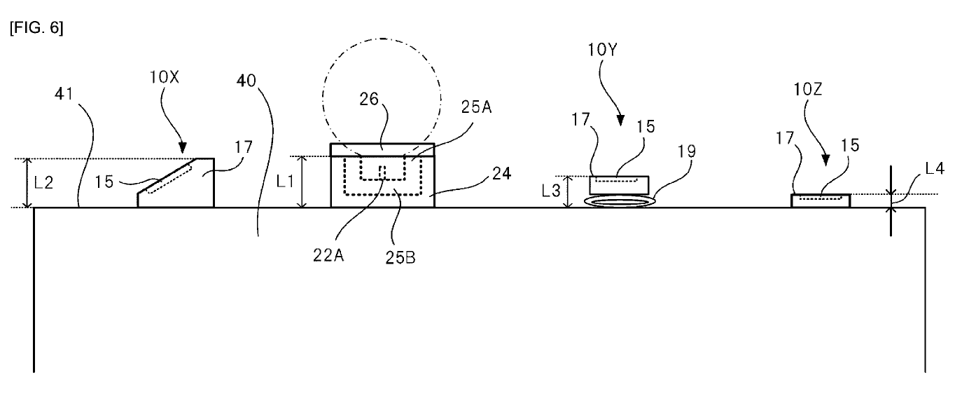

FIG. 6 is a side view illustrating a state in which the upper-arm blood pressure monitor 10X, the wrist blood pressure monitor 10Y, the activity meter 10Z, and the communication device 20 are placed on the placement surface 41. The range indicated by the dot-dash line in the diagram schematically illustrates the radio wave characteristics of the communication device 20, and as illustrated in the diagram, the range has directivity above the placement surface 41.

FIG. 6 illustrates a distance L1 between the placement surface 41 and an upper edge of the radio wave shielding portion 25A of the communication device 20 (an edge on the side opposite to the placement surface 41 side) in the direction perpendicular to the placement surface 41. In addition, FIG. 6 illustrates a height L2 of the main body 17 of the upper-arm blood pressure monitor 10X in the standard placement state (the distance between the placement surface 41 and a portion of the main body 17 farthest from the placement surface 41 in a direction perpendicular to the placement surface 41), a height L3 of the wrist blood pressure monitor 10Y in the standard placement state (the distance between the placement surface 41 and a portion farthest from the placement surface 41 in the direction perpendicular to the placement surface 41), and a height L4 of the activity meter 10Z in the standard placement state (the distance between the placement surface 41 and a portion farthest from the placement surface 41 in the direction perpendicular to the placement surface 41). The size relationship of the height L2, the height L3, and the height L4 is L2 > L3 > L4. The distance L1 of the communication device 20 is equal to or greater than the height L2 of the upper-arm blood pressure monitor 10X, which has the greatest height in the standard placement state among the measurement devices. Among the height L2, the height L3, and the height L4, the greatest height L2 is about 300 mm at the maximum. Among the height L2, the height L3, and the height L4, the lowest height L4 is about 15 mm at the maximum. Thus, if an activity meter or a blood pressure monitor is assumed as the measurement device used in the information analysis system 100, the distance L1 may be set to a range from 15 mm to 300 mm.

The antennas of the first communication units 12 of the upper-arm blood pressure monitor 10X, the wrist blood pressure monitor 10Y, and the activity meter 10Z are non-directional. Since the distance L1 is equal to or greater than the height L2, even when the measurement device (the upper-arm blood pressure monitor 10X, the wrist blood pressure monitor 10Y, or the activity meter 10Z) is placed near the communication device 20 on the placement surface 41, components of radio waves emitted from the measurement device in a direction along the placement surface 41 are shielded by the radio wave shielding portion 25B. Thus, the intensity of the radio waves emitted from the measurement device placed in the vicinity and received by the communication device 20 can be weakened. On the other hand, in a state where the measurement device is placed on the lid portion 26, the intensity of the radio waves emitted from the measurement device and received by the communication device 20 can be increased.

### Pairing Method for Measurement Device and Communication Device

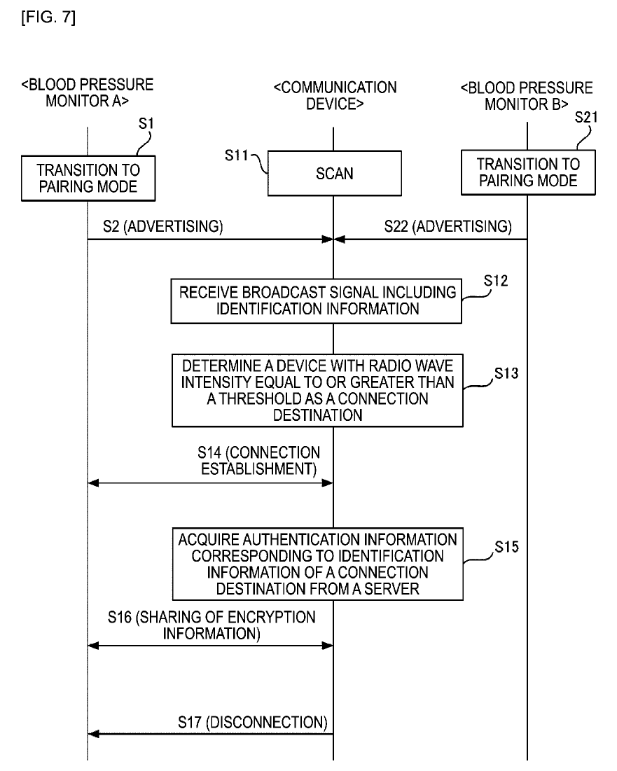

Next, a method for pairing the blood pressure monitor 10 and the communication device 20 will be described. FIG. 7 is a sequence chart illustrating a procedure of processing when pairing a blood pressure monitor A and the specific communication device 20 in a case where the blood pressure monitor A and a blood pressure monitor B exist as the blood pressure monitors 10.

When a researcher turns on the power of the specific communication device 20, the processor 21 of the communication device 20 causes the second communication unit 22 to start scanning. Scan means that the second communication unit 22 enters a reception state and acquires information of surrounding devices.

The researcher turns on the power of each of the blood pressure monitors A and B placed on the placement surface 41, and then presses and holds the communication button 14B included on the operation unit 14 of each blood pressure monitor to put each blood pressure monitor into the pairing mode (step S1, step S21). Thereafter, the researcher places the blood pressure monitor A on the lid 26 of the specific communication device 20.

When pairing mode is transitioned to, the processor 11 of each of the blood pressure monitor A and the blood pressure monitor B activates the first communication unit 12 and causes the first communication unit 12 to start advertising (step S2, step S22). The advertising refers to broadcasting a packet including various kinds of information. Hereinafter, a signal transmitted by the advertising is also referred to as a broadcast signal. The various kinds of information include identification information of the blood pressure monitor 10 (for example, unique address information of the first communication unit 12 and the like). In the information analysis system 100, the identification information of the blood pressure monitor 10 and the authentication information (for example, a six-digit number or the like) necessary for mutual authentication between the blood pressure monitor 10 and another device are associated with each other and stored in advance in a storage unit such as a server connected to a network.

When processor 21 of communication device 20 receives the broadcast signal transmitted from blood pressure monitor A and the broadcast signal transmitted from blood pressure monitor B (step S12), processor 21 determines, as a connection partner, the device with a broadcast signal with a radio wave intensity equal to or greater than a predetermined value from among the blood pressure monitor A and the blood pressure monitor B (step S13). Here, since the blood pressure monitor A is placed on the communication device 20, the radio wave intensity of the broadcast signal of the blood pressure monitor A is equal to or greater than the threshold value, and the radio wave intensity of the broadcast signal of the blood pressure monitor B is less than the threshold value. Thus, the blood pressure monitor A is determined as the connection destination. In step S13, it is preferable to determine, as a connection partner, the device with a broadcast signal with a radio wave intensity that is equal to or greater than a predetermined value and that is the highest.

Next, the processor 21 of the communication device 20 establishes a communication connection with the blood pressure monitor A (step S14). Then, the processor 21 accesses the server via the PC 30 and searches for the authentication information corresponding to the identification information included in the broadcast signal received from the blood pressure monitor A in step S12. If the authentication information exists in the server, the authentication information is acquired from the server (step S15), and the mutual authentication with the blood pressure monitor A is completed using the acquired authentication information. Then, the processor 21 shares encryption information for performing encrypted communication with the blood pressure monitor A via near-field wireless communication (step S16). The sharing of the encryption information means that the processor 11 of the blood pressure monitor A generates the encryption information, stores the encryption information in the storage unit 13, and transmits the encryption information to the communication device 20, and the processor 21 of the communication device 20 stores the encryption information. The processor 21 may generate the encryption information, store the encryption information, and transmit the encryption information to the blood pressure monitor A, and the blood pressure monitor A may store the encryption information in the storage unit 13 to share the encryption information.

Thereafter, the processor 21 disconnects the communication connection with the blood pressure monitor A (step S17). Thereafter, secure communication using the encryption information becomes possible between the communication device 20 and the blood pressure monitor A. Next, the researcher places the blood pressure monitor A on the placement surface 41, and instead, places the blood pressure monitor B on the specific communication device 20 described above. Thus, the processing from step S14 to step S17 is performed between the communication device 20 and the blood pressure monitor B.

In this manner, the researcher can easily complete the pairing of the blood pressure monitor 10 and the communication device 20 only by placing the blood pressure monitor 10 to be paired on the communication device 20. Even in a situation where the blood pressure monitor A is placed on the communication device 20 and the blood pressure monitor B is placed on the placement surface 41, the communication device 20 is prevented from determining the blood pressure monitor B as a connection destination by the effect of the radio wave shielding portion 25A. Since only the blood pressure monitor 10 placed on the communication device 20 can be paired with the communication device 20, the task of pairing each of the multiple blood pressure monitors 10 and the communication device 20 can be efficiently performed.

As illustrated in FIG. 1, when there are a plurality of the communication devices 20, a situation may occur in which the blood pressure monitor A in the pairing mode is placed on one communication device 20 and the blood pressure monitor B in the pairing mode is placed on another communication device 20. Even in this case, if the communication devices 20 are arranged apart from each other to some extent, it is possible to prevent the radio wave intensity of the blood pressure monitor B from becoming equal to or greater than the threshold value in the communication device 20 where the blood pressure monitor A is placed.

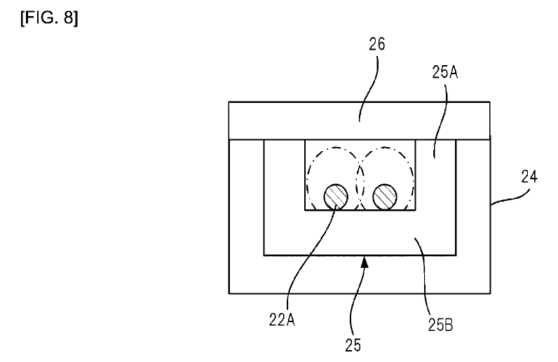

FIG. 8 is a cross-sectional schematic view of the communication device 20 illustrating a modification of the communication antenna 22A mounted on the communication device 20. The communication antenna 22A illustrated in FIG. 8 has a configuration in which a leaky coaxial cable is arranged in a ring shape on the radio wave shielding portion 25B. The leaky coaxial cable emits radio waves only in a range around its axis. Thus, as illustrated by the dot-dash line in FIG. 8, the radio wave emission range of the communication antenna 22A can be limited to, for example, the inside of the recess 25 and the vicinity thereof. As a result, the reception intensity of radio waves from the measurement devices other than the measurement device placed on the communication device 20 can be greatly reduced. Thus, the pairing partner of the communication device 20 can be easily limited to the measurement device placed on the communication device 20, and the pairing task can be efficiently performed.

Although various embodiments are described above, it will be obvious that the present invention is not limited to such examples. It will be apparent to those skilled in the art that various changes and modifications can be made within the scope of the claims, and it is understood that these naturally belong to the technical scope of the present invention. In addition, components of the above-described embodiments may be combined as appropriate without departing from the spirit of the invention.

Note that the present application is based on Japanese Patent Application (Japanese Patent Application No. 2023-093951) filed on June 7, 2023, the contents of which are incorporated herein by reference.

### REFERENCE NUMERALS LIST

10 Blood pressure monitor

10X Upper-arm blood pressure monitor

10Y Wrist blood pressure monitor

10Z Activity meter

11 Processor

12 First communication unit

13 Storage unit

14 Operation unit

14A Measurement start button

14B Communication button

15 Display unit

16 Sensor unit

17, 20M Main body

18 Air tube

19 Cuff

20 Communication device

20C Cable

21 Processor

22 Second communication unit

22A Communication antenna

23 Third communication unit

24 Main body

25 Recess

25A, 25B Radio wave shielding portion

26 Lid portion

30 Personal computer

40 Desk

41 Placement surface

100 Information analysis system

L1 Distance

L2, L3, L4 Height

What is claimed is:

1. A system comprising:
a measurement device including a first near-field wireless communication unit configured to communicate via a communication method capable of pairing; and,
a communication device including a second near-field wireless communication unit configured to communicate via a communication method capable of pairing, wherein:
the communication device includes a radio wave shielding portion erected in a direction intersecting a placement surface and disposed surrounding an antenna of the second near-field wireless communication unit, in a state where the communication device is placed on the placement surface; and,
a distance from the placement surface to an end edge, on a side opposite to a side of the placement surface, of the radio wave shielding portion in a direction orthogonal to the placement surface is equal to or greater than a height of the measurement device placed on the placement surface in the direction.

2. The system according to claim 1, wherein:
the antenna includes a leaky coaxial cable.

3. The system according to claim 1, wherein:
the communication device includes a processor; and,
the processor, in a case where a broadcast signal is received by the second near-field wireless communication unit, performs pairing processing with, from among the measurement devices which are transmission sources of the broadcast signals, the measurement device with a radio wave intensity of near-field wireless communication that is equal to or greater than a threshold.

4. The system according to claim 3, wherein:
the processor obtains identification information of the measurement device corresponding to a target of the pairing and shares encryption information with the measurement device in a case where authentication information corresponding to the identification information can be obtained from a storage unit.

5. A communication device provided with a near-field wireless communication unit configured to communicate via a communication method capable of pairing, the communication device comprising:
a processor, wherein:
an antenna of the near-field wireless communication unit has directivity in a direction orthogonal to a placement surface, in a state where the communication device is placed on the placement surface;
the processor, in a case where a broadcast signal is received by the near-field wireless communication unit, performs pairing processing with, from among devices that are transmission sources of the broadcast signal, a device with a radio wave intensity of near-field wireless communication that is equal to or greater than a threshold; and,
in the processing, the processor obtains identification information of the device corresponding to a target of the pairing and shares encryption information with the device in a case where authentication information corresponding to the identification information can be obtained from a storage unit.

6. A communication device provided with a near-field wireless communication unit configured to communicate via a communication method capable of pairing, the communication device comprising:
a radio wave shielding portion erected in a direction intersecting a placement surface and disposed surrounding an antenna of the near-field wireless communication unit, in a state where the communication device is placed on the placement surface, wherein:
the antenna has directivity in a direction orthogonal to the placement surface, in a state where the communication device is placed on the placement surface.

7. The system according to claim 2, wherein:
the communication device includes a processor; and,
the processor, in a case where a broadcast signal is received by the second near-field wireless communication unit, performs pairing processing with, from among the measurement devices which are transmission sources of the broadcast signals, the measurement device with a radio wave intensity of near-field wireless communication that is equal to or greater than a threshold.
